(19) United States
(12) Patent Application Publication
(10) Pub. No.: US 2004/0054611 A1
(43) Pub. Date: Mar. 18, 2004

(54) Apparatus and method for automated transacting of annuities

(76) Inventors: Robert Benjamin Franks, Sheffield (GB); Richard Clegg, Sheffield (GB)

Correspondence Address: HARNESS, DICKEY & PIERCE, P.L.C., P.O. BOX 828, BLOOMFIELD HILLS, MI, 48303, US

(21) Appl. No.: 10/316,416

(22) Filed: Dec. 11, 2002

(30) Foreign Application Priority Data
Sep. 18, 2002 (GB) PCTGB2002004237

(51) Int. Cl. G06F 17/60

(52) U.S. Cl. 705/36

(57) ABSTRACT

A renewals instruction and transaction interface and method of collecting renewals instructions through an open access interface 2001 available to the public over a communications network 106 is provided. The application of known renewals rules and official fee and service charge cost data to a minimum data set 601 enables a renewals order to be transacted over a communications network 106 without the need to revert to any offline communications. The order can be automatically confirmed to both the service provider 104 and the user 100. The user 100 can further take advantage of the renewals instructions interface to input data to an intellectual property right database 503 held by the transaction server 102 which can be accessed through a restricted access 2002 portfolio management application 2008.

### FIELD OF THE INVENTION

The present invention relates to apparatus and methods for instructing renewals and payment of renewal fees, and particularly, although not exclusively, to an apparatus and method for instruction of registered intellectual property rights renewals and payment of associated renewal fees electronically.

### BACKGROUND TO THE INVENTION

Conventionally, there are many commercial transactions which involve payment of annual fees, for example membership subscriptions, insurance policies, fees to professional bodies, fees to government or intergovernmental bodies for maintaining rights or privileges, and the like. These type of transactions do not require the subscriber, or person paying the amounts due, to shop around for a better price for the basic fee or cost to be paid, because the fees are set by a body to whom the fees must be paid, according to fixed rates which are in general non-negotiable. Examples are subscriptions to professional bodies where membership depends upon timely payment of a subscription fee, payments to government offices such as intellectual property offices for maintenance of intellectual property rights, payment of taxes for particular purposes, for example vehicle excise duty which is due at set periods and at fixed amounts.

Because the nature of these transactions are time sensitive, that is to say the loss of rights or privileges depend upon timely payment of the fees, generally the body charging the fees issues a reminder to members, subscribers or persons wishing to maintain rights notifying them that the rights will lapse unless a renewal fee or subscription is paid by a specified date. These reminders are conventionally sent via normal surface mail.

For some types of fees, there exists commercial organizations which act as intermediary between the person paying a fee, and a body to whom the fee must be paid. Such organizations exist for example where a number of different fees need to be paid in different countries annually, perhaps in different currencies, and at different times in the year. Where a person has a number of different fees to pay at regular intervals, perhaps at different government bodies of different countries, where the fees are payable in different currencies and at different times of the year, it is convenient to use a commercial agent who, due to the volume of such transactions for a plurality of customers, is able to efficiently administer such payments, and keep abreast of variations in payment periods, changes in administrative procedures necessary to pay fees, changes of addresses of the fee charging bodies and other administrative procedures. Such organizations generally charge a service charge/fee to a person wishing to pay fees, in addition to the actual fee to be paid.

Problems with the present known systems for payment of fees include:

Delays in payment incurred by use of postal reminders for subscriptions, fees or the like, the postal communications incurring a delay time in arriving at the addressee.

Language problems incurred by receiving a reminder from a fee charging body in a foreign language, which needs to be understood by a person paying the fees, or by an agent paying the fee on behalf of the end fee payer.

Where an intermediate agent is used, additional bureaucracy and cost incurred by involvement of the agent.

Reminder of communications from the fee charging body to the fee payer or the fee payer's agent.

Intellectual property rights, particularly registered intellectual property rights such as patents, utility models, registered designs and design patents and registered trade marks typically require renewal at predetermined time intervals from a renewals base date in order to maintain the intellectual property right in force. Whilst some intellectual property rights are renewable indefinitely e.g. registered trade marks, many intellectual property rights are only renewable for a predetermined time limit. The interval between necessary renewals operations required to maintain an intellectual property right in force varies between countries/regions and between the types of intellectual property rights. The duration of a renewal period, the maximum time limit for which an intellectual property right can be maintained in force by renewal, the level of official fees payable to effect renewal and further specific renewal requirements are typically all laid down under national/regional legislation and/or associated rules and regulations. Together these laws and rules form a set of predetermined renewals rules applicable to a specified intellectual property right type in a specified country/region. To provide an indication of the variation in renewals requirements, the following examples have been provided:

A UK patent, once granted, can be maintained in force for a maximum period of 20 years from the filing date of the patent application in the UK. The first renewal fee is payable in respect of the fifth year of the patent and is due, in normal circumstances, to be paid on the fourth anniversary of the filing date. Annual renewal fees are required to be paid thereafter to maintain the patent in force. If the UK patent is granted in the period of 3 months ending with the fourth or a succeeding anniversary it is possible to pay the prescribed renewal fee in the period of 3 months from the date on which the patent is granted.

European patents require renewal fees to be paid in respect of the third and subsequent years from the filing date of the European patent whilst the application is pending before the European Patent Office.

UK and European Community registered trade marks are required to be renewed at 10 year intervals from the filing date. Renewal of a UK or European Community trade mark can occur indefinitely.

UK registered designs are renewable at 5 year intervals for a cumulative maximum term of 25 years, typically the renewals base date is defined by the date of filing of the UK registered design application.

In order to maintain United States patents in force it is necessary to pay maintenance fees. Maintenance fees must be paid at the following intervals:

i) After 3 years and 6 months from the original grant;

ii) After 7 years and 6 months from the original grant;

iii) After 11 years and 6 months from the original grant.

It is to be noted that US patents have a renewals base date defined by the date of original grant of the patent, not the filing date.

In certain cases renewal of registered intellectual property rights requires additional action to the payment of a renewal fee. For instance, maintenance of a US registered trade mark can require the filing of affidavits with evidence of use of the mark in commerce within the US.

Not only are the rules governing the requirements for renewal and the date upon which renewal falls due subject to variation between countries/regions, but changes in national or regional law mean that renewals requirements continue to vary and it can be that a registered intellectual property right granted prior to a change in the relevant renewals rules is subject to a first set of renewals rules whilst a later granted registered intellectual property right of the same type and from the same country/region is the subject of a second set of renewals rules.

In most cases, renewal of a registered intellectual property right requires notification at an Industrial Property Office that renewal is required and, in order to effect renewal, this request is usually required to be accompanied by payment of an appropriate official fee. Official fees are typically laid down by the office administering the registered intellectual property right, typically a Central Industrial Property Office e.g. Patent Office. Renewals fees are commonly the subject of review and vary from year to year. It is known for official renewals fees to go down as well as up. Official renewal fees are typically published and are publicly available.

Where an intellectual property right holder chooses to instruct an agent to ensure that renewal of an intellectual property right is timely attended to, that agent will usually incur a service charge/fee in addition to the official renewal fee.

Both the official renewal fee and service charge are known to vary, in some circumstances, depending on the year of renewal.

Traditionally, in the prior art, firms specializing in the renewal of intellectual property rights, particularly registered intellectual property rights such as patents, registered trade marks, registered designs and design patents and, in some countries registered copyright, are known to exist. Such firms typically rely on a large volume of registered rights entered into their systems. Rights holders with large intellectual property portfolios rely on such services to ensure all of their intellectual property rights are maintained in force. With the expansion of the internet, some of these existing firms have expanded their services, to some extent, to take advantage of the platform provided by the internet.

Computer Patents Annuities Limited Partnership (CPA) is an existing firm providing services for the renewal of patents, designs and trade marks. CPA have an online presence at cpajersey.com and provide a service known as ‘CPA Direct’. CPA Direct allows existing CPA clients to enter a restricted access web environment by entry of a group code, user name and password. This allows the client to view cases on the CPA system in their own portfolio and to cancel the previously instructed renewal of individual cases online. The extent of providing online instructions is limited to the cancellation of existing renewal instructions within a restricted web environment. New clients are required to place work with CPA via traditional routes e.g. surface mail, only once the work is placed with CPA can a group code, user name and password be obtained to view cases and cancel existing renewal instructions in a restricted access online environment.

Acumass (www.acumass.com) are a patent renewals and annuities facilities management providing intellectual property portfolio consultation and renewals on the internet. The site is a restricted access site allowing only registered users to enter the renewals instruction area. It is not possible for members of the public to visit the site and instruct renewal of an intellectual property right on their first visit.

www.pavis.de provides an intellectual property right renewals service. As with other existing online renewal services, a log-in number and password is required in order to instruct or adjust renewal instructions. Any person visiting the site must be a registered user in order to gain access to the data input platform.

EP 1115076 A1 discloses a reminder and actioning system which responds to approaching due dates by sending e-mails to the clients to which they relate. Each e-mail contains links such that the client can be taken to an instruction giving web page. The web page lists the approaching due dates and allows the client to instruct the operator to perform the actions due. The due dates may be for the payment of patent, design or trade mark renewal fees. This system basically comprises the maintenance of an information record for determining due dates. As a date approaches an e-mail is sent to the relevant client. The client responds by instructing completion of the necessary action. The e-mail message includes means for causing the client entity to request a page from the hosts hyper-media server means. The client is not provided with means to input renewals data and request calculation of future renewals dates and costs information. The system basically comprises the sending of a message and receipt of an instruction.

WO 01/24035 A2 describes a fee transaction system and method for intellectual property acquisition and/or maintenance. A computer implemented method for transacting an intellectual property service is described. The method comprises presenting a user with one or more intellectual property services and associated fees wherein the user selects one or more of the services, resulting in initiating performance of the selected service and transaction of the associated fees. The system does not provide for the user inputting data relating to existing intellectual property rights in a plurality of countries/regions and does not provide for calculation of renewal cost based on the data input by the user. In contrast, the system relies on pre-existing docket data, subsequently presenting to the user intellectual property matters which require an instruction from the user.

Whilst traditionally, intellectual property renewals have a legacy of being instructed through the agent who handles the pre-grant prosecution of the intellectual property rights. Increasing competition in the renewals market means that increasingly intellectual property right holders are seeking to cut the cost of service charges for renewal. At present, an intellectual property right holder cannot visit an online web-site, enter details of the right to be renewed and receive a quote for that renewal and a confirmation of the next renewal date. There is also a need in the market for providing an automated service for accepting renewals instructions which is accessible to all members of the public via the internet.

The prior art therefore provides a technical problem in that it is not possible to obtain automated quotes or estimates for executing renewals transactions in respect of intellectual property rights. It is further not possible in the prior art to access a publicly available internet site, enter details of an intellectual property right along with payment details, receive a calculated next renewals date and cost and instruct a renewals operation.

### SUMMARY OF THE INVENTION

The inventors have realized the difficulties presented in the prior art in obtaining rapid, accurate quotes for the renewal of intellectual property rights. The inventors have also recognized the problems in the prior art of rapidly and accurately instructing renewal of a registered intellectual property right at short notice without the need to register with an agent or at a web-site to establish a client—agent relationship.

The inventors have further realized that an open access internet platform enabling users to enter data identifying a registered intellectual property right to obtain an accurate and reliable quote or estimate for carrying out that renewal is particularly advantageous to intellectual property rights holders who normally attend to their own renewals and may have overlooked, or be too busy to attend to, renewal of that right or to intellectual property rights holders who are uncertain how to achieve renewal in a specific territory and wish to instruct an agent at short notice.

Specific embodiments and methods according to the present invention aim to automate routine payments of the fees which are in general non-negotiable and which are set according to predetermined scales, and which must be paid by predetermined times.

One object of the present invention is to achieve improved operation of an intermediate agent and improve communication of the intermediate agent with a plurality of fee charging bodies and the client and for improving the efficiency and reliability of fee payment transactions between the intermediate agent and the plurality of fee charging bodies.

According to a first aspect of the present invention, there is provided a computer entity configured to receive intellectual property right renewals data from a user computer entity via a communications network, said renewals data identifying said intellectual property right and comprising:

data identifying a country/region; and

data identifying an intellectual property right type; and

renewals base date data;

wherein, said computer entity comprises a processor component comprising:

a renewals date calculator; and

a renewals cost information calculator;

said computer entity further comprising a communications component to communicate the calculated renewal date and cost information to said user computer entity.

According to a second aspect of the present invention, there is provided a computer entity configured to receive intellectual property right renewals data from a user computer entity via a communications network, said renewals data identifying said intellectual property right and comprising:

data identifying a country/region; and

data identifying an intellectual property right type; and

renewals base date data;

wherein said computer entity comprises processing means comprising:

means to calculate a next renewal date; and

means to calculate renewals cost information;

said computer entity further comprising means to communicate the calculated next renewal date and cost information to said user computer entity.

According to a third aspect of the present invention, there is provided a computer entity configured to receive intellectual property right renewals data from a user computer entity via a communications network, said renewals data identifying said intellectual property right and comprising:

data identifying a country/region; and

data identifying an intellectual property right type; and

renewals base date data;

wherein, said computer entity comprises a processor component comprising:

a renewals date calculator;

said computer entity further comprising a communications component to communicate the calculated renewal date to said user computer entity.

According to a fourth aspect of the present invention, there is provided a system for automated transacting of intellectual property right renewals, said system comprising:

a plurality of computer entities connected to a communications network;

a first user computer entity comprising a renewals data inputter for input of renewals data to a data file at a computer generated display interface, said renewals data comprising data identifying an intellectual property right and a renewals base date;

said first user computer entity further comprising a communications component for submitting said data file to a second remote computer entity via said communications network, said second remote computer entity comprising:

a processor component, said processor component comprising:

a renewals date calculator; and

a communications component to submit calculated renewals date information to said first user computer entity;

said first user computer entity configured to transmit an order confirmation message to said second remote computer entity.

According to a first specific method of the present invention, there is provided a method of instructing intellectual property rights renewals via a communications network, said method comprising the steps of:

inputting renewals data to a data file at a computer generated display interface, said renewals data comprising data identifying said intellectual property right and a renewals base date;

communicating said renewals data to a remote computer entity, said remote computer entity applying known renewals rules to said renewals data to calculate a next renewal date;

displaying order information at said computer generated display interface.

According to a second specific method of the present invention, there is provided a method of instructing intellectual property rights renewals via a communications network, said method comprising the steps of:

inputting renewals data to a data file at a computer generated display interface, said renewals data comprising data identifying said intellectual property right and a renewals base date;

communicating said renewals data to a remote computer entity, said remote computer entity applying known renewals rules to said renewals data to calculate a next renewal date; and

said remote computer entity applying a cost data set to said calculated next renewal date to determine a renewal cost;

displaying order information at said computer generated display interface.

According to a third specific method of the present invention, there is provided a method for automated transacting of intellectual property renewals, said method comprising the steps of:

inputting renewals data to a data file at a computer generated display interface, said renewals data comprising data identifying said intellectual property right and a renewals base date;

submitting said data file to a remote computer entity comprising a processing means:

processing said renewals data to calculate a future renewals data set:

displaying calculated future renewals information at said computer generated display interface; and

receiving order confirmation at said remote computer entity.

According to a fifth aspect of the present invention, there is provided a computer program product directly loadable into the internal memory of a digital computer, said computer program product enabling instruction of intellectual property rights renewals via a communications network, said computer program product comprising software code portions for:

generating a computer display interface for input of renewals data to a data file at the computer generated display interface, said renewals data comprising data identifying said intellectual property right and a renewals base date;

applying known renewals rules to said renewals data to calculate a next renewal date;

displaying order information at said computer generated display interface.

According to a sixth aspect of the present invention, there is provided an interface, for inputting data relating to an intellectual property right, said data sufficient to enable renewal of said intellectual property right, said interface comprising:

a data file input component, for inputting a selected data file, said selected data file comprising data identifying said intellectual property right;

wherein, said interface is accessible to the public via a communications network.

According to a seventh aspect of the present invention, there is provided an intellectual property right renewals instruction order form, automatically computer generated in response to a renewals instruction input at a computer generated display interface and submitted to a remote computer entity via a communications network, said order form comprising:

data identifying an intellectual property right, said data sufficient to enable renewal of said intellectual property right.

According to an eighth aspect of the present invention, there is provided an intellectual property right renewals confirmation form, automatically computer generated in response to a renewals instruction input at a computer generated display interface and submitted to a remote computer entity via a communications network, said confirmation form comprising:

data identifying an intellectual property right; and

renewals cost data; and

an order confirmation message.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically components of an online transaction system for enabling instructions to renew intellectual property rights to be provided online over a communications network;

FIG. 2 illustrates schematically hardware and software components of the transaction system of FIG. 1;

FIG. 3 illustrates schematically an architecture for layout of display views produced by an interface according to a specific implementation of the present invention;

FIG. 4 illustrates schematically an overall logical architecture of a transaction system of the present invention;

FIG. 5 illustrates schematically an overall logical architecture of a portfolio management system according to the present invention;

FIG. 6 illustrates schematically data fields of a renewal order file, illustrating different types of data to be collected by the transaction system of FIG. 1;

FIG. 7 illustrates schematically an interactive display interface, for collection of data according to a specific implementation of the present invention;

FIG. 8 illustrates schematically the interactive display interface of FIG. 7, further illustrating a facility for the collection of trade mark data;

FIG. 9 illustrates an interactive prompt for the collection of data relating to the size of proprietor entity;

FIG. 10 illustrates a US trade mark renewals information text display;

FIG. 11 illustrates schematically a zone menu of the interactive display interface of FIG. 7;

FIG. 12 illustrates schematically an intellectual property right type selection menu of the interactive display interface of FIG. 7;

FIG. 13 illustrates schematically an expanded data entry form of the interactive display interface of FIG. 7;

FIG. 14 illustrates schematically a mode of operation of the transaction system, wherein a user enters a selection of a zone and intellectual property right type and renewals information for a first time in a data entry operation;

FIG. 15 illustrates schematically a renewals instruction summary view displaying information input by the interface of FIG. 7 according to a second embodiment of the present invention;

FIG. 16 illustrates schematically a renewals instruction summary view displaying information input by the interface of FIG. 7 according to a first embodiment of the present invention;

FIG. 17 illustrates schematically a second view of the display interface of FIG. 7, for collection of client data;

FIG. 18 illustrates schematically a third view of the interface display of FIG. 7, for collection of payment data;

FIG. 19 illustrates schematically a process flow diagram for construction and operation of the transaction system according to the best mode specific implementation;

FIG. 20 illustrates schematically an architecture for layout of an open access end and restricted access end of the transaction system of the present invention;

FIG. 21 illustrates schematically an intellectual property right data entry file, illustrating different types of data to be collected by a portfolio management engine;

FIG. 22 illustrates schematically a portfolio management display interface;

FIG. 23 illustrates schematically a renewals instruction order form for instructing a service provider;

FIG. 24 illustrates schematically a renewals instruction confirmation form for confirming the renewals instruction to a client.

### DETAILED DESCRIPTION OF THE BEST MODE FOR CARRYING OUT THE INVENTION

There will now be described by way of example the best mode contemplated by the inventors for carrying out the invention. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

In this specification the term intellectual property right (IPR) comprises patent, utility model, registered design, design patent, trade mark (both registered and unregistered), domain names, unregistered design right, unregistered copyright and registered copyright. A registered intellectual property right comprises any intellectual property right of which record is maintained on a centrally administered register (e.g. the register of UK patents administered by the UK Patent Office) such register typically containing information relating to the date of registration and identifying the right holder.

In this specification the term renewal fee means any fee payable in order to maintain an intellectual property right in force. The renewal fee may be due annually or at other defined time intervals and comprises annuity fees and/or maintenance fees. The term renewal operation comprises those steps necessary to ensure a renewal fee is paid in order to maintain the relevant intellectual property right in force.

In this specification a zone comprises a country, region, territory or state in respect of which an intellectual property right may exist, in particular the term “zone” refers to a geographical zone, for which legal rights concerning an intellectual property right can be applied for. A zone can include a state, country, a region, for example the European Union, or a plurality of countries/regions party to a legal protocol, for example countries party to the European Patent Convention.

In this specification the term file identifier used in relation to an intellectual property right comprises information sufficient to accurately identify a single intellectual property right or bundle of related intellectual property rights.

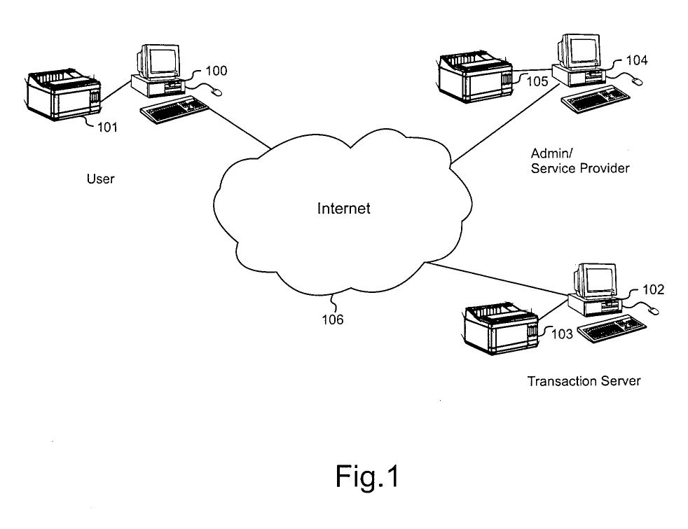

Referring to FIG. 1 herein, there is illustrated schematically components of a transactional system according to a best mode implementation of the present invention. The system comprises one or a plurality of user terminals 100, being conventional personal computers, Macintosh® computers or the like, being provided with a conventional browser, and having access to a conventional printer device 101 for printing hard copy of received e-mail documents and/or screen views; a transactional computer 102 comprising a remote computer entity to user terminal 100, with optional associated printer device 103, operating to provide an on-line interface display accessible by each of the user terminals 100, and generating an administration interface display, accessible to modify or enter data relating to intellectual property right renewals, including geographical zones, costs, laws and procedures and the like, the transactional computer capable of carrying out on-line transactions for the fulfillment of orders and instructions for renewal of intellectual property rights by a service provider entity; and a service provider computer 104, comprising a conventional PC, Macintosh® computer, or the like, equipped with a printer 105, and a conventional browser, the service provider computer 104 operable to access the transactional computer 102 to receive transaction orders collected by the transactional computer, and apply changes of data relating to intellectual property rights renewals, on stored databases of the transactional computer 102.

The transactional computer 102, can communicate with the user computers 100 via a known communications network, for example a virtual private network, wide area network, local area network, or the internet 106 as are known in the art; and similarly the transactional computer 102 can communicate with the service provider computer 104. The service provider computer 104 can communicate with the user computer 100 via e-mail as is known in the art.

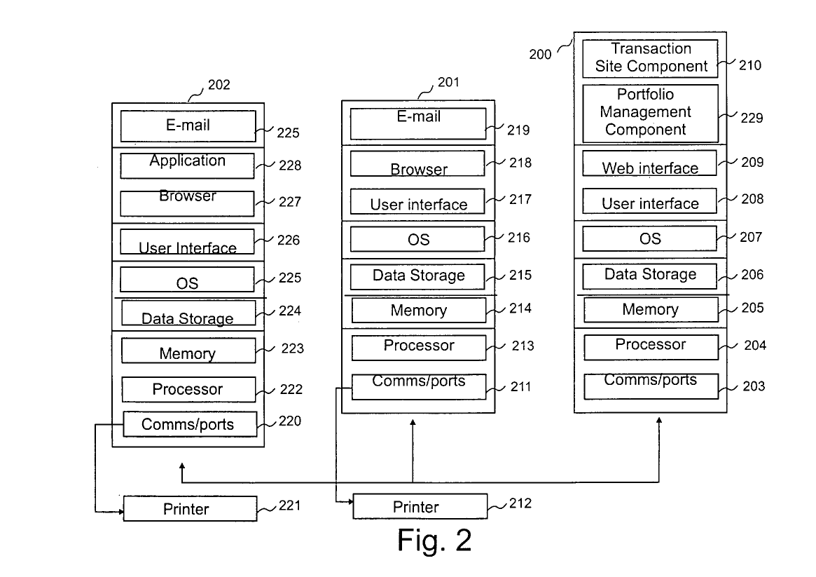

Referring to FIG. 2 herein, there is illustrated schematically components of a transactional computer 200, a service provider computer 201, and a user computer 202 of the system of FIG. 1. Transactional computer 200 comprises a communications port 203; a data processor 204; associated memory 205; a data storage device 206, for example a RAID array or the like; an operating system 207, for example the known Windows2000®, Unix®, or Linuxe® operating systems; a user interface 208, for local administration of the transactional computer, comprising a video monitor, key board, and pointing device such as a mouse or the like; a web interface 209 for displaying HTML web pages to the one or plurality of user computers 202 and one or a plurality of service provider computers 201; a transaction site component 210 and a Portfolio Management component 229. The transaction site component 210 and Portfolio Management component 229 are, in the best mode, implemented as code for operating the processor, memory and data storage devices 204-206 of the transactional computer, under control of operating system 207 to provide functionality for generation of and display of web pages, receiving transaction orders, and forwarding transaction orders to the user computer 202 and service provider computer 201 over a communications network, for example the internet, and for providing access to administration functionality for modification and manipulation of data stored within the transactional server computer 200, by service provider computer 201 and/or user 202.

The transaction site component 210 and Portfolio Management component 229, in the best mode, are implemented as program instructions in a known programming language such as C, C++, or the like, and utilizing HTML for generation of page displays.

Service provider computer 201 comprises a communications port 211, for example a conventional modem for connecting with the transactional computer 200, and also a printer port and driver for driving a printer 212 for printing out a hard copy receipt and order confirmation of received transaction instructions; a data processor 213, for example an Intel®, or the like, processor; associated memory 214 as is known in the art; a data storage device 215, for example a hard disk or an array of hard disk drives; an operating system 216, for example the known Windows 95®, Windows 98®, Windows 2000® or Windows NT®, Unix® or Linux® operating systems; a user interface 217 comprising a video display monitor, a keyboard, for data entry purposes, and a pointing device e.g. a mouse and a set of audio speakers as is known in the art; a browser 218, for example a known Netscape® browser or the like; a conventional e-mail application 219 for receiving and sending e-mails; and one or a plurality of applications, for example graphic applications, audio applications or the like, for opening a wide variety of different file types, for example JPEG, .WAV, PDF, MP3, MPEG, HPGL, or similar files, so that physical printed copy of images containing graphic files can be generated using the printer 212. Similarly, where audio applications are provided, a user can play a sound over a set of speakers contained in the user interface 217.

The user computer 202 can be any computer entity available to be connected on-line, for example any known computer entity which is internet enabled, as is known in the art, and comprises a communications port 220, optionally with a printer driver for driving a printer device 221; a processor 222, including any known processor type, for example an Intel® processor or the like; memory 223 as is known in the art, a data storage device 224, for example a hard disk drive; a known operating system 225 for example a Windows®, Macintosh®, Unix®, or Linux® operating system; a known user interface 226 comprising a visual display monitor, keyboard, pointing device e.g. mouse or the like, or a web interface; a known browser 227 for example a Netscape ® browser; optionally a graphics application 228 for storing and/or scanning in image data and storing that image data as a file, for example a JPEG file, PDF file or the like; and optionally an e-mail application 225 for sending and receiving e-mails.

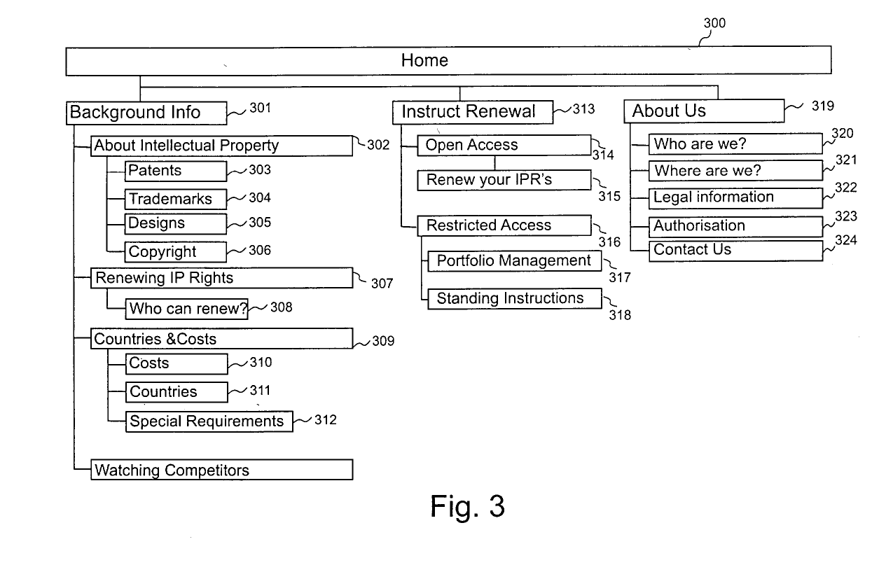

Referring to FIG. 3 herein, there is illustrated schematically a layout architecture for display of a navigation page of the transaction site of the present invention.

A home page 300 is displayed when a user first connects to the transaction site. From the home page, by activating link icons as is known in the art, the user can cause display of either a background information page 301, a renewals instruction interface 313 or an information page 319 describing details about the service provider. In the best mode the home page 300 is configured such that an icon leading to the renewals instruction interface 313 is visually more prominent than icons leading to the background information page 301, or service provider information page 319 so that the user is channeled towards the renewals instruction ordering interface 313 and into the renewals instruction process 315 by an open access display 314. This arrangement means that whilst a user can always access the background information 301 page or service provider information page 319 from the home page 300 a first time user, in terms of probability, is more likely to access the renewals instruction interface 313 thus promoting submission of a renewals instruction. This reduces the risk of the user clicking into cyberspace and encourages the user to instruct a renewals operation.

Since the whole point of the transaction system is to obtain a firm instruction for renewal of one or more intellectual property rights, the service provider ideally does not wish the user to become distracted from the basic operation of data entry leading to a firm renewals instruction. On the other hand, a new user is unlikely to instruct a renewal unless they are satisfied that they understand what they are doing and are satisfied about the soundness and competence of the service provider. Therefore, information about intellectual property 302, particularly patents 303, trademarks 304, designs 305 and copyright 306 is included on the website. Further, specific information on renewals processes for intellectual property rights 307 and on sub-topics e.g. who is eligible to instruct a renewal 308 is also provided. Further information on countries and cost 309 is provided. This may typically be provided by tables of renewals costs 310 which may include lists of both official fees and services charges along with lists of countries/regions 311 where the service provider is able to cause renewal to be successfully completed. Further information on particular special requirements 312 for renewal in certain countries is also provided. Further information in terms of watching for competitors renewals and other due diligence services are optionally provided. The overall objective, as far as the service provider is concerned, is to draw the user into the process of instructing an intellectual property right renewal without getting lost, becoming frustrated or clicking away into cyberspace before the renewals instruction is completed. To accommodate this, the visual design of the home page and renewals instruction pages should be such that in terms of relative sizes, an icon leading to the renewals instruction interface 313 is of a larger area and more visually prominent than icons leading to the background information page 301 or service provider information pages 319.

The service provider information pages 319 comprises pages describing who the service provider is 320, their physical location 321, legal information 322 describing the service providers status and qualifications, information regarding any requirements to authorise the service provider 323 and contact details 324.

The renewals instruction interface comprises a renewals instruction web page which is open access 314 being accessible without restriction (i.e. requirement for password, user name and registration procedure) to all members of the public over a communications network, typically the internet. The open access forum allows for direct instruction of intellectual property right renewals without a prior client-service provider/agent relationship being in existence.

The renewals instruction interface may optionally be complimented by a restricted access end of the interface which is only accessible via a registration procedure to obtain a user name, password and the like. The restricted access end 316 may optionally be configured to provide a portfolio management system 317 which allows for the creation of lists of the clients intellectual property rights and forthcoming renewals tables, dates and budgets. The restricted access end 316 may optionally further provide for the instigation of, or alteration of, standing instructions 318 regarding aspects or the entirety of a clients intellectual property portfolio.

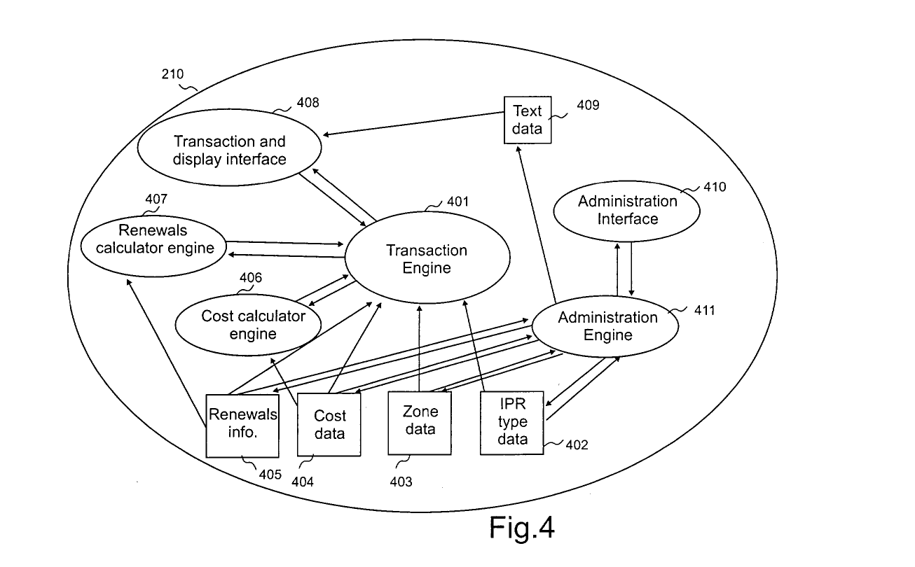

Referring to FIG. 4 herein, the transaction site component 210 of the transaction server 200 comprises a transaction and display interface 408 for generating an interactive graphical display capable of displaying information and inputting data; a transaction engine 401 for receiving data input at the display and transaction interface 408; a cost calculator engine 406 for calculating costs corresponding to different renewals operations in different countries/regions in respect of a plurality of intellectual property right types, calculated according to the intellectual property rights renewals data input at the transaction and display interface 408. For instance, renewal of a trade mark may require information relating to the number of classes of goods/services for which the application is registered. The cost calculation engine 406 calculating the cost of renewal in respect of the specified number of classes of goods/services. The transaction site component 210 further comprises a renewals calculator engine 407 for calculating future renewal dates; a cost database 404 storing tabulated data on official renewal costs for one or a plurality of countries/regions; a zone database 403 for storing a list of countries/regions where intellectual property rights may exist; data relating to available types of intellectual property rights 402 and a renewals information database 405 containing information describing renewals rules, such rules comprising renewals interval data, renewals operations data and information describing various renewals requirements based on the law and regulations describing the renewal requirements in one or a plurality of countries/regions. The transaction component 210 further comprises a text data file 409 for storing text data describing procedures and information relating to renewals operations and the service provider; an administration interface 410 allowing the service provider computer entity to modify data contained in the cost database 404, zone database 403, intellectual property right (IPR) type database 402 and renewals information database 405, and also allowing the service provider to view details of transaction orders received and print out those details; an administration engine 411 is also provided to provide functionality for driving the administration interface 410.

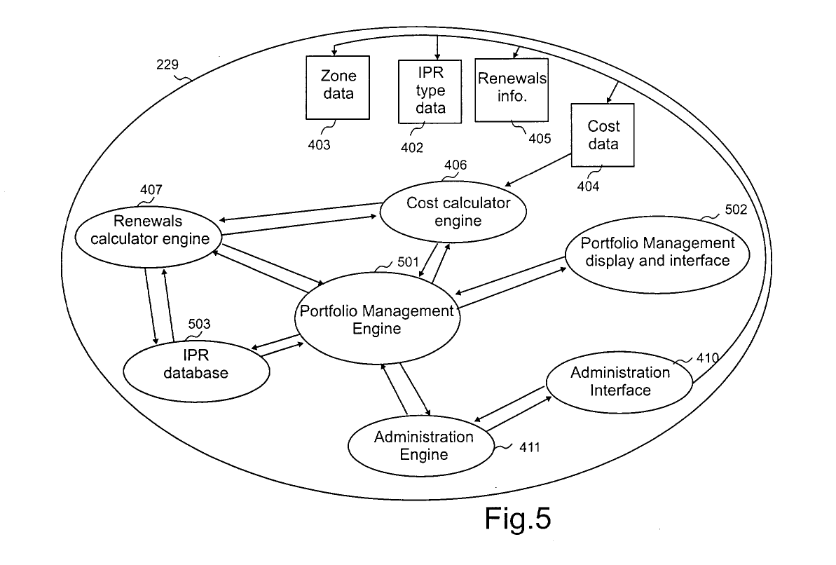

Referring to FIG. 5 herein portfolio management component 229 comprises a portfolio management display and interface 502 for generating an interactive graphical display capable of displaying information and inputting data; a portfolio management engine 501 for receiving data input via the display and interface 502; a cost calculator engine 406 for calculating costs corresponding to different renewals operations and instructions in different countries/regions; a renewals calculator engine 407 for calculating future renewals dates; an intellectual property right database 503 comprising data relating to one or a plurality of clients' intellectual property right portfolios including data identifying intellectual property rights held by that client and/or rights which the client may have an interest in; an administration interface 410 is provided allowing the service provider computer to modify data contained in the cost database 404, zone database 403, intellectual property right type database 402 or renewals information database 405.

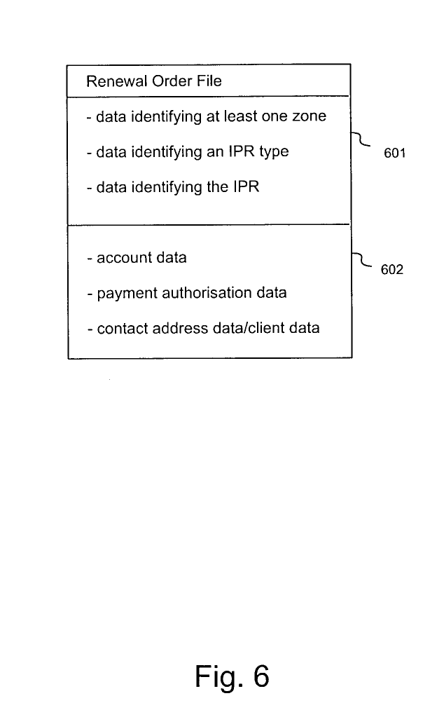

Referring to FIG. 6 herein, there is illustrated schematically a renewal order data file containing the minimum set of data fields necessary for the fulfillment of an online transaction order for instructing a renewal of an intellectual property right, such order enabling the service provider to fulfill the order without the need for manual intervention in contacting the user, for example by telephone, email or fax.

The data types can be classified into two sets 601 and 602; the first set 601 of essential data; a second set 602 of preferred data. If any of the data types identified in the first set 601 are not collected by the transaction interface 408 then successful renewal will require intervention from the service provider to contact the user or alternatively the user contacting the service provider direct.

The minimum data types 601 which must be collected for successful renewal comprise:

data identifying at least one zone, this data should identify at least one country or region in which the intellectual property right to be renewed exists;

data identifying an intellectual property right type, this data includes information relating to the type of intellectual property right which is to be renewed e.g. patent, trade mark, design or utility model;

data identifying the intellectual property right, such data is typically a file identifier typically being a minimum requirement of one of an application or publication number.

The file identifier should be of a specific nature such that when combined with the information relating to the country/region in which the intellectual property right exists and the type of intellectual property right only one specific intellectual property right is identified.

The minimum data type 601 must be collected in order to allow the service provider to effect successful renewal of the intellectual property right.

The renewal order file ideally also contains a second set of data 602 which relates to administration of the order and which, whilst not absolutely essential for the successful completion of the renewals operation are important to the commercial prospects of the service provider and the service provider is unlikely to wish to provide the renewals service unless the second data types are provided by the user. These non essential data types include:

data identifying a financial account, either a credit card account, debit card account or bank account or other financial account details from which transfer of due fees can be authorised and effected;

payment authorization data enabling collection of payment from the financial account; and

contact address data identifying a person (ideally the client) to whom the service provider can refer in respect of the application, the contact address data comprising either a telephone number, an email address and/or a physical address or any combination of such addresses.

The renewal order file may optionally comprise further data, such data may further identify the intellectual property right e.g. applicant data, details of publication of the intellectual property right, priority data or seniority data.

As it is not possible to effect a renewal without being able to identify the intellectual property right required to be renewed the essential data items in data set 601 will always have to identify a country/region, type of intellectual property right and some form of file identifier for the specific right to be renewed. Whilst various further data types may, as an option available to the service provider, be flagged for collection by the interface, the collection of superfluous data to that required to perform the renewals operation will increasingly result in a user having to pass over more hurdles in order to file an order. Additionally, the user may not understand the difference between a publication date and a priority date, therefore if the service provider specifies that both of these data types must be entered before an order can be completed, then the chances of that order being completed are correspondingly reduced.

In the best mode, the service provider specifies which data types must be collected, bearing in mind the more data types which were specified as being essential, the lower the chances of receiving an automated order. However, a minimum data set must be specified as being essential in order to receive sufficient information so that the service provider can effect successful renewal of intellectual property rights.

There will now be described operation of the instruction system for collection of data describing one or more intellectual property right renewals instructions.

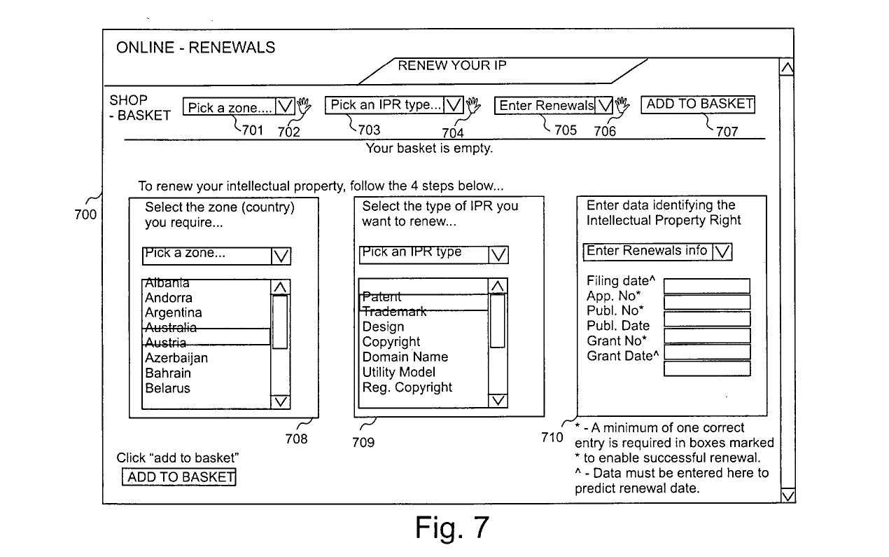

Referring to FIG. 7 herein, there is illustrated an instructing page display 700 presented by the renewals instruction interface 313 where a user enters the renewals instruction process 315. The instruction page comprises a display to which data can be input to order a renewals operation. This ordering page display comprises a substantially rectangular display. A plurality of menu options are provided. A first drop down menu 701 is identified by the text “pick a zone . . . ” and invites a user to select a geographical zone, typically a country or state and in some cases a region e.g. Europe. A second drop down menu 703 is provided identified by the text “pick an IPR type . . . ” inviting the user to select a type of intellectual property right which is to be renewed e.g. patent. A third drop down menu 705 is identified by the text “enter renewals info . . . ”. Clicking on the third drop down menu 705 invites the user to identify at least a minimum data set 601 to enable the intellectual property right to be renewed to be identified by the service provider. Once the information required has been accurately input the user can click on the “add to basket” icon 707 to add the order to their shopping basket. Help icons 702, 704, 706 are provided to link the ordering page display page to help menus and text to aid the user in completing the electronic form. The user is further guided by the display by the example form filled in. The user is guided to the fact there are four simple steps to follow, firstly a zone is selected 708 by scrolling down to an appropriate zone and clicking on that zone, secondly an IPR type is selected 709 by scrolling down an IPR selection menu and clicking as appropriate and thirdly a minimum data set is required to be entered to an electronic enter renewals information form 710. The user is required to input information into a minimum number of the spaces provided on the form. First and second embodiments of the present invention require differing levels of information to be input into the electronic form 710.

In a first embodiment of the present invention the user is required to input either a filing date or grant date (this requirement depending upon the zone selected and the type of IPR right selected, for instance if the “United States” and “Patent” is selected it is necessary to input the grant date as this is the date from which renewals is calculated). Additionally either an application number or publication number or grant number is required to identify the IPR right, this is the file identifier. In this first embodiment of the present invention the filing date or grant date provide a renewals base date, that is the date from which the date of future renewals due is calculated and the application number or publication number or grant number provide a file identifier. For a UK patent only the filing date and application number need be input to establish both a renewals base date and a file identifier. However, the user could input a filing date and publication number or filing date and grant number and still enable the service provider to locate the correct patent and enable the renewals engine to calculate the date of future renewals by using the filing date as the renewals base date.

In the first embodiment of the present invention, where a user does not input sufficient information they are invited to complete the information required on the electronic form 710 and are informed that the order cannot be accepted until sufficient information has been provided.

In the first specific embodiment of the present invention the transaction engine 401 comprises renewals calculation engine 407 and cost calculation engine 406. Having established a renewals base date the renewals calculation engine 407 can apply renewals information 405 to calculate the next date of renewal, that is the latest date by which renewal must be completed to maintain the rights in force without incurring a surcharge. Additionally the cost calculation engine using data on both the service provider charges and relevant official renewal fees held in the cost database 404 can calculate both a service provider cost and official fee cost for renewal.

In a second specific embodiment of the present invention the ordering page display 700 is configured such that it is only necessary to enter renewals information to establish a file identifier, that is either an application number or publication number or grant number or any combination of these. In the absence of a renewals base date e.g. filing date or grant date as applicable it is not possible for the renewals calculation engine 407 to calculate the next due renewal date. As official fees for renewal commonly vary with the year of renewal it is also not possible for the cost calculation engine 406 to calculate an official fee cost of renewal. However, a fixed service provider fee can be calculated. Therefore, in the second specific embodiment of the present invention transaction engine 401 is not required to comprise renewals calculation engine 407, as an essential component.

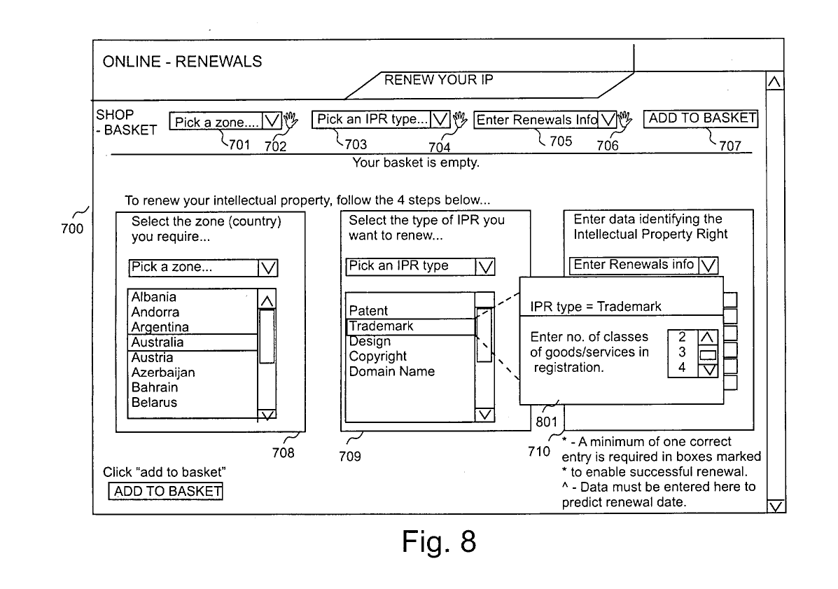

FIG. 8 illustrates the page display of FIG. 7 wherein the type of intellectual property right has been selected as a “trade mark”. As the cost of renewal of registered trade marks, in particular the official fee, tends to vary with the number of classes of goods/services for which the mark is registered it is necessary, in most cases, to establish how many classes of goods/services are in the trade mark registration. Therefore, on the user selecting the option “trade mark” in menu 703 they are prompted to enter a number of classes of goods/services using a scroll down menu via a prompt 801.

Referring to both FIG. 7 and 8 herein, once the user has selected sufficient information to enable the renewals order to be instructed they are asked to click “add to basket” and the renewals order is placed in a storage area which the user can access to view their unconfirmed orders via the shopping basket.

Selected renewals operations involve special requirements in the form of varying levels of fees depending on the size of the proprietor entity or requirements to file specific legal documents e.g. renewal of certain registered trade marks where evidence of use is required to be filed to maintain the registration in force.

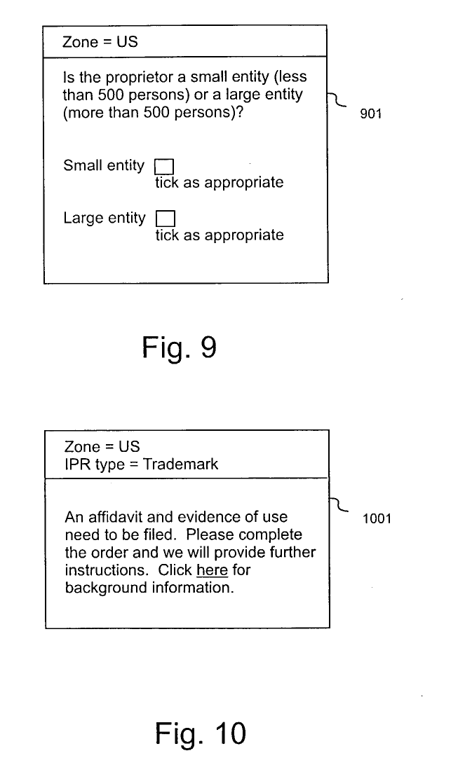

Referring to FIG. 9 herein a display 901 is illustrated asking the user to indicate whether the proprietor of the intellectual property right is a small entity or large entity. This is required to ensure the correct fee payment is made in certain states e.g. the US and Canada. Whilst this is not an essential requirement for instructing renewal as, in all cases the larger fee can be paid as a default, it is preferable to obtain this information. Accordingly, transaction engine 401 is configured to recognize particular combinations of zone and IPR type to prompt certain questions regarding such special requirements. FIG. 9 illustrates one such possible question.

Referring to FIG. 10 herein an information display 1001 is illustrated in a situation where the transaction engine 401 recognizes the combination of the zone=US and IPR type=trade mark. In this case the user is informed that it will be necessary to file an affidavit and evidence of use to maintain the mark in force and that they will be contacted by the service provider with the appropriate information in due course. Optionally, the user can then be prompted to click an icon to view the background information pages on the relevant subject matter.

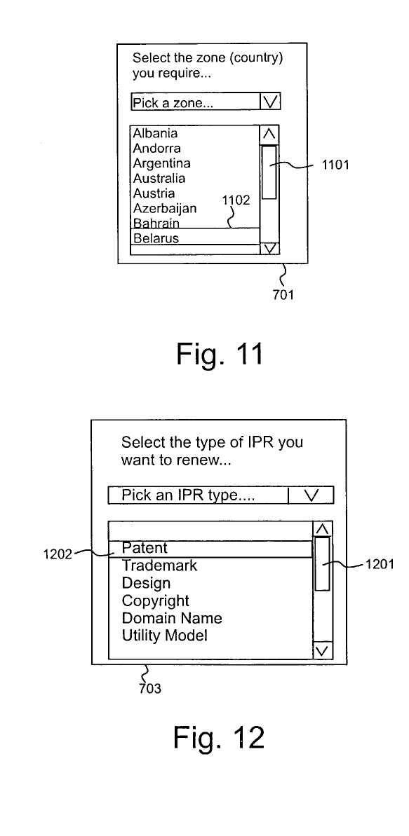

Referring to FIG. 11 herein, there is illustrated schematically operation of zone menu 701. Zone menu operates as a drop down menu display. Drop down menu displays per se are known in the art. However, in this case, the drop down menu is modified to display a list of zones in alphabetical order, which can be selected by a user by placing a pointer icon over a displayed zone text and activating the icon, for example double clicking a pointing device such as a mouse. FIG. 11 illustrates a selection of zone “Bahrain” 1102 and operates as a scroll down menu with a scrolling bar 1101.

Referring to FIG. 12 herein, there is illustrated schematically an IPR type selection menu 703 comprising a scroll down bar 1201. A user is invited to select one of several types of intellectual property right e.g. patent, utility model, trade mark, design, copyright or domain name. FIG. 12 illustrates the user to have selected patent 1202.

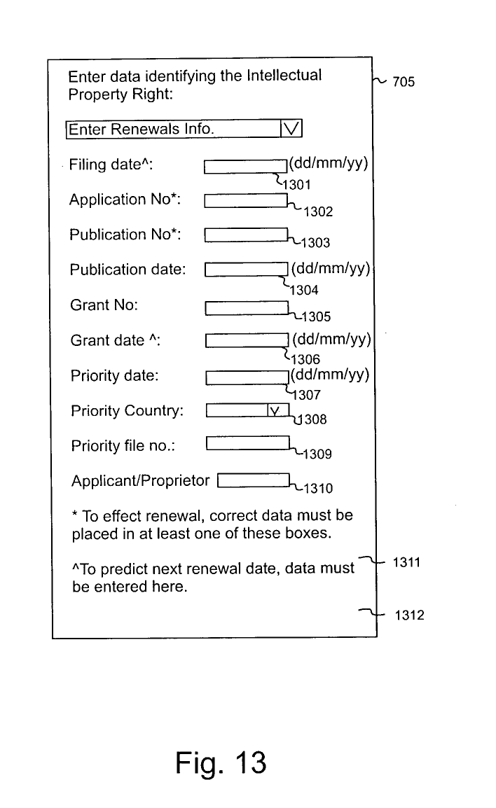

Referring to FIG. 13 herein, the drop down menu 705 inviting the user to enter renewals information is illustrated. FIG. 13 illustrates an expanded electronic form to that illustrated in FIG. 7 and the present invention may use either form type to gain sufficient information to ensure that a renewals operation is instructed. The drop down menu 705 comprises an electronic form with a series of data fields where data can be input. It is not necessary for the user to input data into every field type, but if they do, this information may be held on the transaction server computer entity and be used in creating an intellectual property right database for a particular client who may then access that information via an associated portfolio management system.

The electronic form illustrated in FIG. 13 is compatible with both the first and second specific embodiments of the present invention.

In the first specific embodiment of the present invention the renewals calculation engine 407 and cost calculation engine 406 are configured to use information contained in the cost database 404, zone database 403, intellectual property right type database 402 and renewals information database 405 to establish a latest date by which the next renewal can validly occur (i.e. a due date for renewal) with or without any applicable official surcharge fee as well as both the official fee cost and service provider charge for carrying out that renewal. In order to obtain this information a minimum data set 601 must be input at the electronic order form 705. This minimum data set comprises:

a renewals base date; and

a file identifier.

Renewals base date enables calculation of the next renewal date by the renewals calculation engine 407 when used in conjunction with information from renewals information database 405 and drop down menus 701 and 703 combining information on a selected zone and IPR type.

The file identifier when used in conjunction with the selected zone and intellectual property right type enables the correct intellectual property right to be identified by the service provider for renewals.

In terms of the information which the user needs to input, a renewals base date can be provided by either: an intellectual property right filing date or an intellectual property right grant date. The filing date being the date of filing confirmed by the relevant intellectual property office in a filing receipt issued for that intellectual property right or such equivalent date. The grant date typically being the date of grant of the intellectual property right confirmed by the relevant intellectual property office or other such equivalent date.

In the first specific embodiment of the present invention the renewals calculation engine is configured to compare the selected zone and intellectual property right type with renewals information database 405 to establish whether a filing date or grant date is required. As such, the filing date or grant date is automatically flagged in the electronic form 705 so that the user is directed towards having to input information to the selected fields. For instance, where the zone United States is selected and the IPR type patent is selected the field grant date 1306 is flagged with a suitable marker 1311, 1312 to indicate that data must be input in this field in order to instruct the renewals operation. Alternatively, where the zone United Kingdom is selected and the IPR type patent is selected the transaction engine configures form 705 such that the user is only required to input the filing date 1301 to establish a renewals base date for calculation of future renewals.

In order to efficiently instruct a renewals operation without having to revert to an offline process of directly contacting the user, the user is always required to input a file identifier. A file identifier may comprise one or more of the following:

an application number typically being the application number assigned to an intellectual property right application upon its filing; or

a publication number being the publication number assigned to publication of the intellectual property right; or

a grant number typically being the number assigned to the granted intellectual property right.

In some cases these numbers may be identical, for instance it is typical for the publication and grant numbers of a UK patent to be identical except for a characterizing letter following the grant number. As a practical matter such characterizing letters are not critical to the identification of the particular file.

Accordingly, in the second specific embodiment of the present invention where a date of next renewal is not calculated by the transaction engine it is only necessary to input a file identifier in form 705, the file identifier typically being an application number, publication number or grant number as described above.

Form 705 illustrated in FIG. 13 can provide an additional function to that of renewals instruction. Where a user who is the proprietor of the right to be renewed wishes to create an online user accessible portfolio management system for their intellectual property, entering data into all of the fields illustrated in form 705 can enable direct entry and submission of information into an intellectual property right database 503. Thus, depending upon the requirements of the user and the implementation of the interface, form 705 can be varied from having available data fields for input of a minimum requirement of the information required to establish a renewals base date and file identifier to an expanded form of the type shown in FIG. 13, namely data fields for inputting the following:

Filing date 1301; Application number 1302; Publication number 1303; Publication date 1304; Grant number 1305; Grant date 1306; Priority date 1307; Priority country 1308; Priority file number 1309; Applicant/proprietor name 1310.

Further referring to FIG. 7 herein, the instruction ordering page display 700 is arranged such that an unsophisticated user having little or no knowledge of intellectual property rights renewals requirements or procedure may immediately become aware that in order to proceed with the renewals instruction process the user needs to select a zone, intellectual property right type and input a minimum amount of information. The layout of the display teaches the user how to select a zone, IPR type and to input the required information and then directs the user to add to the order by using the icon “add to basket”.

Further, first help icon 702 is positioned immediately adjacent to the zone menu 701 such that it is immediately apparent to a user that help information describing the zone menu can be accessed by selecting that first help icon. On activating the first help icon, there appears a pop up text box containing a brief summary of how to select a zone. In order to proceed, the user must close the help text box, and on closing the help text box the view reverts to the ordering page view. It is preferable that within the help text no provision is made to access other areas of help on other subjects other than the zone menu, since to do so may encourage a user to become distracted from the basic process of data entry. Second and third help icons 704 and 706 are similarly arranged.

The logical structure of the display interface 700 is such that a user can commence a data entry operation either by first entering a zone or intellectual property right type or renewals information. Whichever point the user chooses to start to enter data, the interface does not allow the user to proceed without completing the remaining data entry requirements to provide the necessary data to identify the intellectual property right to be renewed.

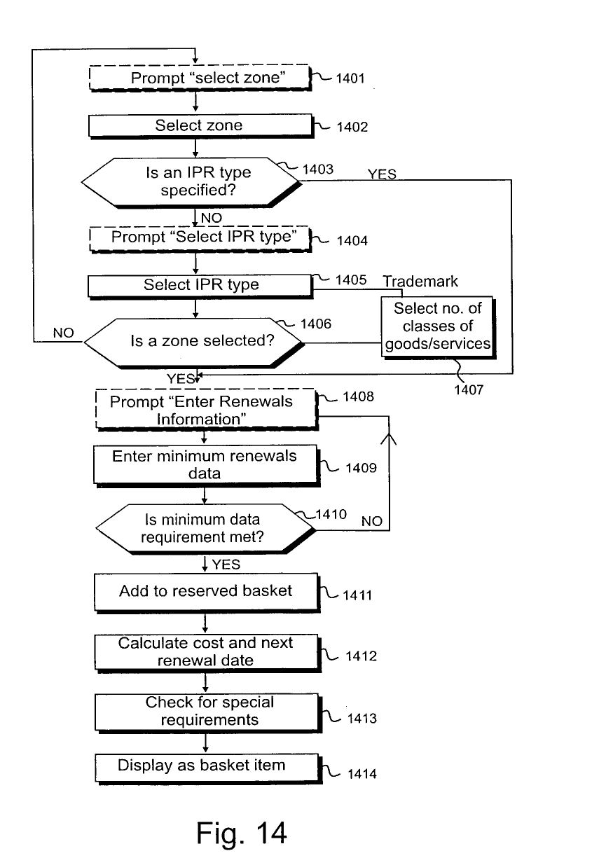

Referring to FIG. 14 herein, there is illustrated schematically a process carried out when a user is presented with the interface display of FIG. 7 for the first time, and enters a first selection of zone, intellectual property right type and renewals information.

The user can commence the process at either step 1402, by selecting a zone from the zone menu 701, or at step 1405 by selecting an intellectual property right type from the IPR menu 703, or at step 1409 by entering renewals information at the renewals information data entry form 705.

In the case where the user commences at step 1402 by selecting a zone they are initially prompted to select a zone in step 1401 via drop down menu 701. The zone is subsequently selected in step 1402. Subsequently if no intellectual property right type is specified 1403 the user is prompted to select an IPR type 1404 which is then selected in the drop down menu 703 in step 1405. If a user selects the IPR type “trademark” they are prompted to select a number of classes of goods/services which is selected in step 1407. If a zone has not been selected and the user entered the process at 1403, a check is made 1406 and a prompt to select the zone 1401 is given. Whilst the user may initially enter the process by entering renewals information normally the user would initially select a zone then an intellectual property right type and then enter renewals information. In any event, where renewals information is still required to be input a prompt 1408 is displayed the user can then enter the renewals information 1409 via a drop down menu and electronic form 705. A check is made to ensure that the minimum data set has been entered to ensure that a renewals instruction can be successfully delivered and a renewals operation successfully carried out, once this information has been input the order is added to the reserved basket 1411 a cost calculation and next renewal date calculation step is undertaken 1412. Optionally a check for special requirements e.g. filing of evidence 1413 may be made and if special requirements are applicable a suitable text message or further menu options may be displayed to the user. The completed unconfirmed order is then displayed as a basket item 1414.

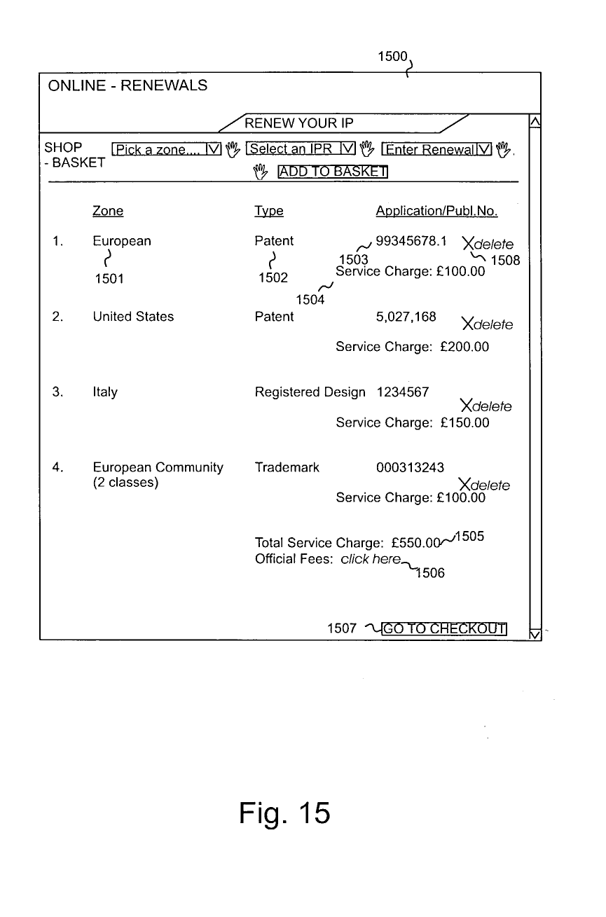

Referring to FIG. 15 herein, there is illustrated schematically a renewals instruction summary order display 1500 which illustrates the contents of the user shopping basket prior to confirming the order. FIG. 15 illustrates a summary display according to the second embodiment of the present invention in this case the user has input data to select a zone, intellectual property right type and a file identifier e.g. application number or publication number or grant number. The example indicates that the user has input information to instruct renewal of four intellectual property rights. The first instruction instructs renewal in the European zone 1501 of a patent 1502 of application number 99345678.1 (1503). The user is given the option to delete 1508 one or more of the instructions prior to confirming the order. In the case of the fourth unconfirmed instruction in respect of a European Community trade mark the user is informed that the service provider will be informed that there are two classes of goods/services in the registration. For each order a service charge 1504 has been calculated by the cost calculation engine 406 using fixed service charge cost data contained in the cost database 404. The cost calculation engine enables a service charge from the provider to be calculated by comparing the zone and intellectual property right type. As a renewals base date is not given in this embodiment it is not possible for the cost calculation engine to apply varied service charges per year of renewal and the service charge must be fixed. The alternative is to go off line to seek an estimate from the service provider.

Accordingly, a total service charge 1505 can be provided. The total official fee cost cannot be provided automatically. The user can be directed by clicking on the official fees icon 1506 to a table of official fees held in the background information 301 section. Once the user is satisfied with the order they can click the “go to checkout” icon 1507.

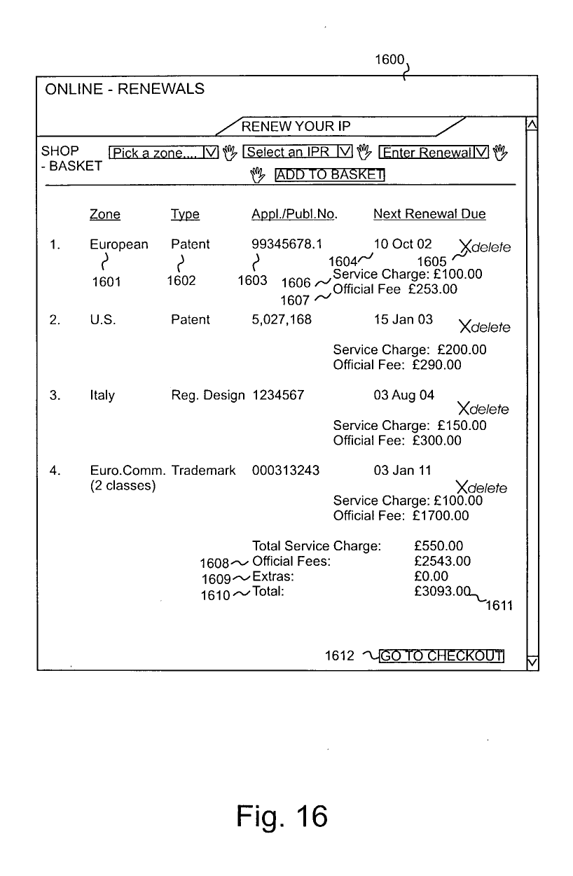

Referring to FIG. 16 herein, there is illustrated schematically an order summary display showing unconfirmed renewals instructions for a number of intellectual property rights renewals which the user has requested according to the first specific embodiment of the present invention. In the first embodiment the user is required to input data to select a zone and an intellectual property right type (1601, 1602) the user is also required to input the file identifier 1603 and a renewals base date. By inputting a renewals base date the renewals calculation engine 407 can use data from the renewals information database 405 to calculate the date on which the next renewal is due 1604. Resultantly, the year of next renewal e.g. 3rd year or 4th year etc. can also be calculated and this can be fed into the cost calculation engine 406 to determine the official fee cost and service charge for renewal in that period. As a result the order summary 1600 can display the zone information 1601, intellectual property right type information 1602, a file identifier 1603, a date upon which the next renewal is due by 1604, the service charge for that renewal 1606 and the correct official fee for that renewal 1607.

The user has the option to delete one or more of the orders by clicking the delete icon 1605 adjacent each unconfirmed order.

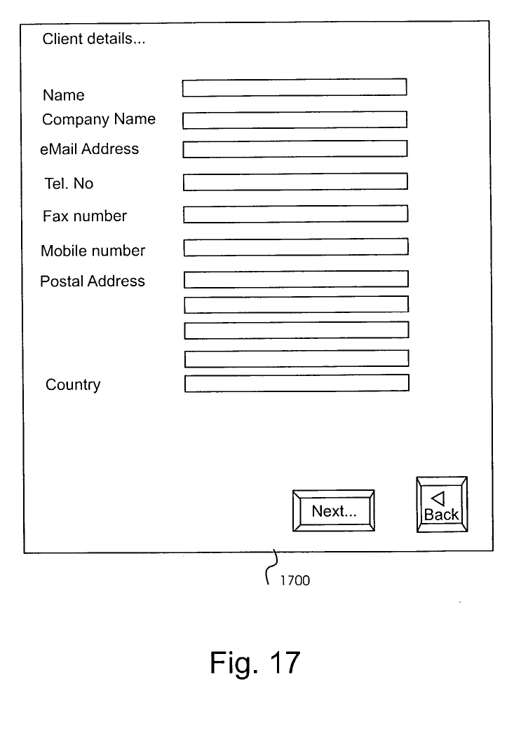

The total service charge 1608 can be calculated as well as the total official fee charge 1609. In case of special requirements there may be extra charges which can also be displayed as extras 1610. A grand total 1611 can thereby be calculated. Once the user is satisfied with the displayed order information they are invited to click the “go to checkout” icon 1612 to proceed and confirm the order. Clicking “go to checkout” leads the user to the display illustrated in FIG. 17.

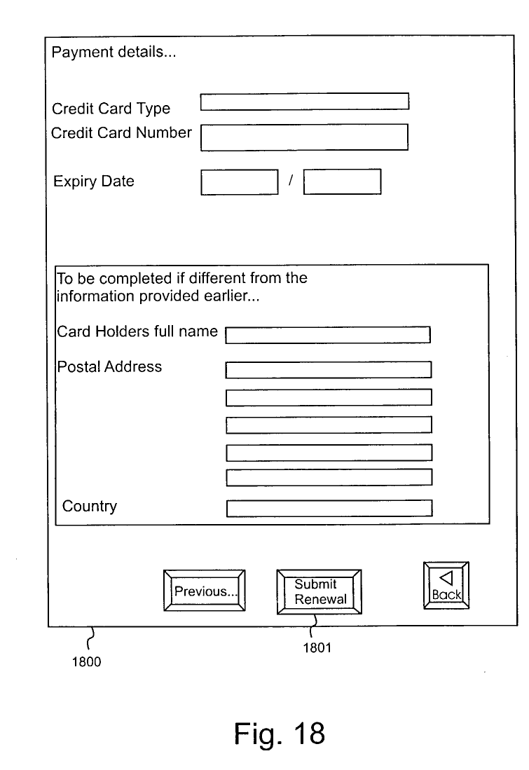

Referring to FIG. 17 herein, client details display 1700 comprises data entry fields for entry of client name, company name (if different), email address, telephone number, fax number, postal address, country. The client details display 1700 relates to collection of data identifying the client and collection of contact address data. Clicking “next” leads the user to the display illustrated in FIG. 18.

Referring to FIG. 18 herein, there is illustrated schematically a payment details display 1800 for implementing collection of payment details. The payment details display comprises data fields for entering a credit card type, credit card number, expiry date of credit card, a name holder of a credit card and postal address and country of credit card. Entry of payment details via display as shown in FIG. 18 are known in the art. There is also provided either as part of the payment display, or alternatively elsewhere on the interface, an icon for stepping back to a previous display, and an icon for submitting the renewals instruction as a confirmed order. Activation of the submit renewal icon 1801 submits the order in full to the transaction server 102 as a confirmed order. The transaction server can then confirm the order with the service provider 104 via a communications network 106 to effect renewal.

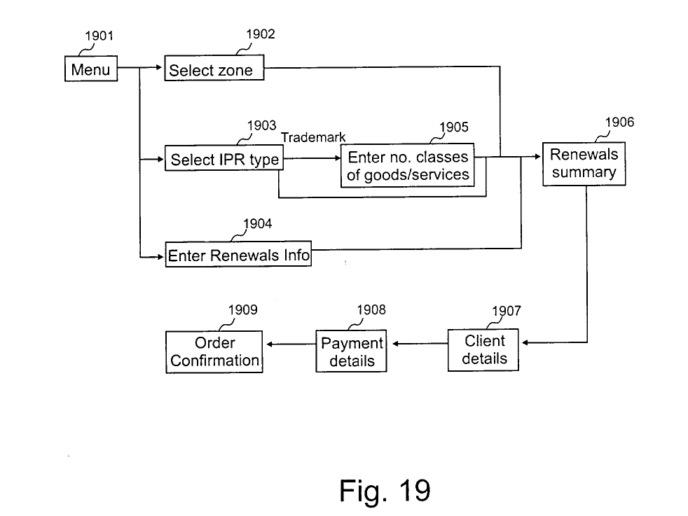

FIG. 19 illustrates a logical process for the data entry mechanism. From a main menu 1901 the user is directed to an interface for renewals instruction wherein they are prompted to select a zone 1902, an IPR type 1903, and to enter renewals information to an electronic order form 1904. Where the intellectual property right type is a trade mark the user is requested to enter a number of classes of goods/services 1905. Only when a minimum data set has been entered to identify an intellectual property right for renewal can the order proceed. Submitting the entered information enables calculation of a renewals summary sheet 1906 where the user can manipulate and alter renewals instructions. Proceeding beyond the renewals summary sheet the client is requested to input client details 1907 and payment details 1908 before confirming the order 1909.

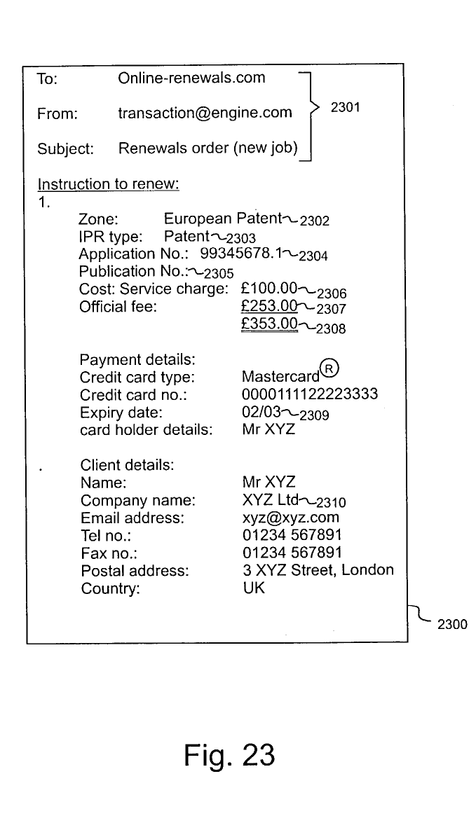

Referring to FIG. 23 herein, there is illustrated a renewals instruction confirmation form 2300. This form is automatically generated by the transaction server on receipt of a confirmed renewals instruction and is compiled using data input by the user. Typically, the confirmation form comprises an email sent automatically to the service provider. Alternatively communication could be by fax, letter or other communication means. The renewals instruction order form comprises address information 2301 and specific instruction information. The instructions to renew comprise data and information describing a zone of renewal 2302 a type of right to be renewed 2303 a file identifier e.g. application number 2304 or publication number 2305 and information regarding cost comprising official fee information 2307 and/or service charge information 2306 and a total charge to be made 2308. Payment details 2309 enable advanced payment to be taken prior to completing the renewals order. Client details 2310 are also confirmed to the service provider.

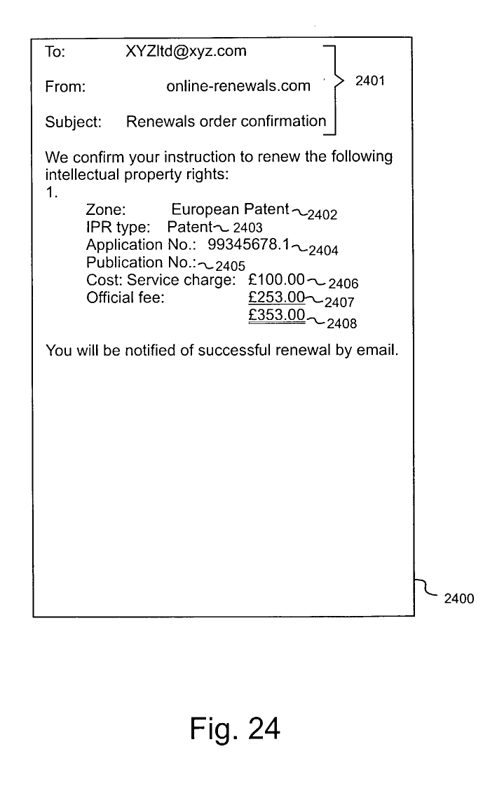

Referring to FIG. 24 herein, there is illustrated a renewals instruction confirmation order communication comprising an automatically generated form generated by the transaction server on receipt of a confirmed order from the user. The form typically comprises an email sent to the clients email address but can take the form of a fax or other communication. Form 2400 comprises address information 2401, a statement of confirmation of the renewal instruction along with specific details of the renewal. The example shown in FIG. 24 illustrates confirmation of the zone of renewal 2402, type of intellectual property right to be renewed 2403, file identifier e.g. application number 2404 or publication number 2405 or grant number. Additionally, confirmation of the cost including official fee 2407 and/or service charge 2406 and a grand total charge being made 2408 is confirmed.

Whilst it is largely a matter of good practice and courtesy to confirm to the client the receipt of an instruction, and of specific instructions that have been received by the service provider, it is of particular importance that the service provider receives a communication from the transaction server indicating the renewals instructions.

An important feature of the present invention is that the interface for instructing and transacting renewals is an open access interface available to members of the public freely and without restriction over a communications network e.g. the internet. By providing such an open access interface all members of the public can obtain a renewals quote or estimate and instruct renewals at short notice without the need to have a pre-existing client-agent relationship with the service provider. As the interface is an open access interface no passwords, usernames or other login parameters specific to particular users are required to gain access to the renewals instruction interface. However, there is no limitation on providing a restricted access end to the interface.

In a further embodiment of the present invention there is provided a restricted access end to the interface of the present invention, said restricted access end comprising interactive interfaces accessible to established/registered users having designated log in criteria.

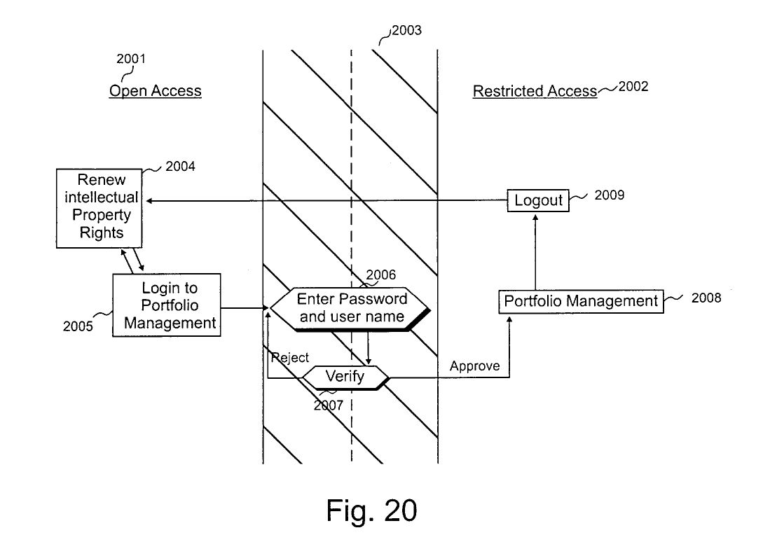

Referring to FIG. 20 herein, a logical architecture of the further embodiment of the present invention is illustrated schematically. The open access 2001 end of the interface comprises a renewals instructing and transacting interface 2004. Users accessing the open access 2001 area can also navigate to a login page 2005. The login page 2005 requires users to input login criteria e.g. user name, group name and password which form specific identifiers unique to the user. First time users wishing to obtain access to a restricted access 2002 end of the web site are required to enter a registration process (not shown) to obtain their user specific unique identifier. At the log-in page 2005 the user is prompted to enter a password and user name and other identifying criteria which may be specified 2006, this information is communicated to the transaction server which verifies 2007 the password and user name and communicates a rejection or approval to the user. Once the information exchange 2003 between the transaction server and user computer entities results in approval of the password and user name the user can enter the restricted access 2002 end of the web site. Typically the restricted access area comprises a portfolio management application 2008. Once the user has completed required operations in the restricted access 2002 area a log-out operation 2009 is required to return to the open access end 2001 of the website.

The portfolio management application enables manipulation of portfolio data. Referring to FIG. 5 herein, the transaction server computer entity comprises a portfolio management engine 501. An interface 502 allows a registered user to access an intellectual property rights database 503 to create data displays relating to registered users intellectual property. Renewals instructions and the corresponding renewals information is retained in the intellectual property right database 503.

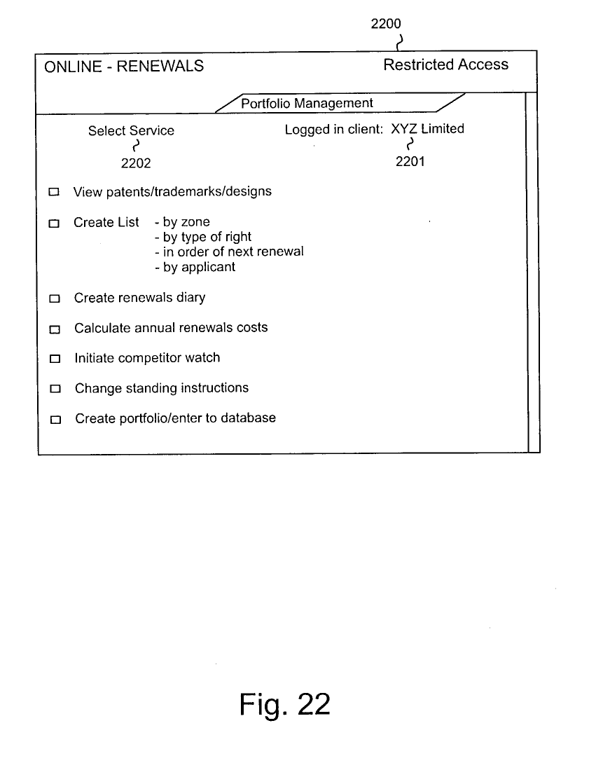

Referring to FIG. 22 herein, a computer generated display interface 2200 for portfolio management in a restricted access end of the web site is illustrated. The logged in client is indicated 2201 and the user is asked to select a service 2202. The user may view intellectual property rights in the logged in clients name and use the viewed information to create lists of intellectual property rights held on the intellectual property right database 503. By application of the renewals calculator 407 and/or cost calculator 406 a future renewals diary and annual renewals costs and budgets can be created. Facilities can also be provided enabling the user to instruct further operations such as a watch of competitors patents in a particular name or an instruction to change any standing instructions e.g. to discontinue renewals of French registered trade marks in the name XYZ Limited.

Whilst the intellectual property right database 503 can be compiled using information input by the user at the open access 2001 renewals instructing 2004 end of the interface, this information can further be supplemented by direct input of intellectual property rights information at the restricted access end 2002 of the web site. In this way the portfolio information held at the transaction server can be supplemented.

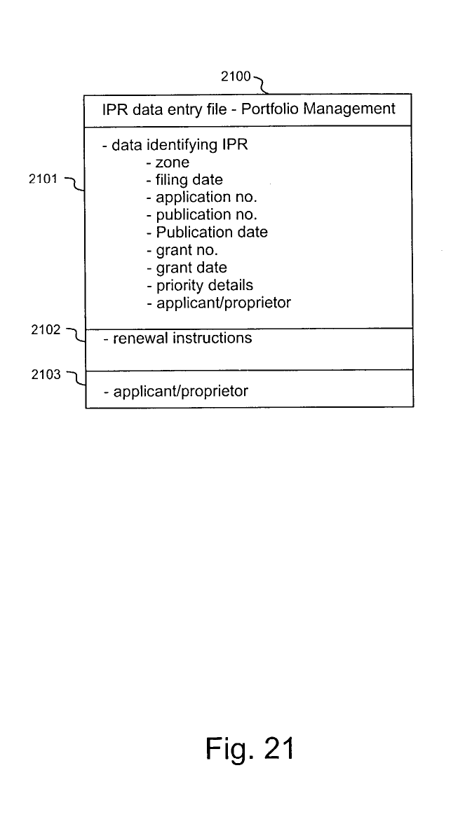

Referring to FIG. 21 herein, an intellectual property rights data entry file for input of data to the intellectual property rights database 503 through the portfolio management 2008 application is illustrated. The data entry file 2100 comprises one or a plurality of information types identifying an intellectual property right 2101. An electronic form of the type illustrated in FIG. 13 can be used for this operation. Optionally, specific renewals instructions 2102 can also be input and details of the applicant/proprietor 2103 can also be entered.

The present invention therefore provides a novel renewals instruction and transaction interface and method of collecting renewals instructions through an open access interface available to the public over a communications network. By applying known renewals rules and official fee and service charge cost data to a minimum data set a renewals order can be transacted over a communications network without the need to revert to any offline communications. The order can be automatically confirmed to both the service provider and the user. The user can further take advantage of the renewals instructions interface to input data to an intellectual property right database held by the transaction server which can be accessed through a restricted access portfolio management application to which access is restricted to registered users only. A particular registered user capable of accessing only a specified data set for which clearance is provided.

1. A computer entity configured to receive intellectual property right renewals data from a user computer entity via a communications network, said renewals data identifying said intellectual property right and comprising:
data identifying a country/region; and
data identifying an intellectual property right type; and
renewals base date data;
wherein, said computer entity comprises a processor component comprising:
a renewals date calculator; and
a renewals cost information calculator;
said computer entity further comprising a communications component to communicate the calculated renewal date and cost information to said user computer entity.

2. A computer entity as claimed in claim 1, wherein said data identifying said intellectual property right further comprises a file identifier.

3. A computer entity as claimed in claim 1, wherein said renewals date calculator comprises a renewals engine, said renewals engine comprising:
information describing renewals requirements and time limits in a plurality of countries/regions.

4. A computer entity as claimed in claim 1, wherein said renewals cost information calculator comprises a cost calculation engine, said cost calculation engine comprising:
official fees data relating to the cost of official renewal fees per renewal period for renewal of at least one intellectual property right type in a plurality of countries/regions.

5. A computer entity as claimed in claim 1, wherein said renewals cost information calculator comprises a cost calculation engine, said cost calculation engine comprising:
cost data relating to the service charge for renewal in a plurality of countries/regions, for at least one intellectual property right type, in respect of a plurality of renewal periods.

6. A computer entity as claimed in claim 1, wherein said renewals cost information calculator comprises a cost calculation engine, said cost calculation engine comprising:
official fees data relating to the cost of official renewal fees per renewal period for renewal of at least one intellectual property right type in a plurality of countries/regions and cost data relating to the service charge for renewal in a plurality of countries/regions, for at least one intellectual property right type, in respect of a plurality of renewal periods.

7. A computer entity configured to receive intellectual property right renewals data from a user computer entity via a communications network, said renewals data identifying said intellectual property right and comprising:
data identifying a country/region; and
data identifying an intellectual property right type; and
renewals base date data;
wherein said computer entity comprises processing means comprising:
means to calculate a next renewal date; and
means to calculate renewals cost information;
said computer entity further comprising means to communicate the calculated next renewal date and cost information to said user computer entity.

8. A computer entity configured to receive intellectual property right renewals data from a user computer entity via a communications network, said renewals data identifying said intellectual property right and comprising:
data identifying a country/region; and
data identifying an intellectual property right type; and
renewals base date data;
wherein, said computer entity comprises a processor component comprising:
a renewals date calculator;
said computer entity further comprising a communications component to communicate the calculated renewal date to said user computer entity.

9. A system for automated transacting of intellectual property right renewals, said system comprising:
a plurality of computer entities connected to a communications network;
a first user computer entity comprising a renewals data inputter for input of renewals data to a data file at a computer generated display interface, said renewals data comprising data identifying an intellectual property right and a renewals base date;
said first user computer entity further comprising a communications component for submitting said data file to a second remote computer entity via said communications network, said second remote computer entity comprising:
a processor component, said processor component comprising:
a renewals date calculator; and
a communications component to submit calculated renewals date information to said first user computer entity;
said first user computer entity configured to transmit an order confirmation message to said second remote computer entity.

10. A system for automated transacting of intellectual property renewals, as claimed in claim 9, said processor component further comprising:
a renewals cost information calculator,
said communications component configured to submit calculated renewals cost information to said first user computer entity.

11. A method of instructing intellectual property rights renewals via a communications network, said method comprising the steps of:
inputting renewals data to a data file at a computer generated display interface, said renewals data comprising data identifying said intellectual property right and a renewals base date;
communicating said renewals data to a remote computer entity, said remote computer entity applying known renewals rules to said renewals data to calculate a next renewal date;
displaying order information at said computer generated display interface.

12. The method as claimed in claim 11, wherein said step of communicating said renewals data and applying said known renewals rules further comprises the step of:
said remote computer entity applying a cost data set to said calculated next renewal date to determine a renewal cost.

13. The method as claimed in claim 11, wherein said order information comprises at least one of the following:
Data identifying an intellectual property right;
A renewals base date;
Renewals cost data.

14. The method as claimed in claim 11, wherein said data identifying said intellectual property right comprises:
data identifying a country/region;
data identifying an intellectual property right type;
a file identifier.

15. The method as claimed in claim 11, further comprising the step of:
inputting payment data to a payment data file at said computer generated display interface; and
submitting order information and payment data to said remote computer entity.

16. The method as claimed in claim 11, further comprising the step of:
communicating said order information from said remote computer entity to a service provider computer entity.

17. The method as claimed in claim 11, further comprising the step of displaying a confirmation message at said computer generated display interface.

18. The method as claimed in claim 11, further comprising the step of:
compiling from said input renewals data a user specific portfolio comprising information describing said users intellectual property rights;
said portfolio maintained under restricted access conditions and accessible at said computer generated display interface only by a user authorised party.

19. A method of instructing intellectual property rights renewals via a communications network, said method comprising the steps of:
inputting renewals data to a data file at a computer generated display interface, said renewals data comprising data identifying said intellectual property right and a renewals base date;
communicating said renewals data to a remote computer entity, said remote computer entity applying known renewals rules to said renewals data to calculate a next renewal date; and
said remote computer entity applying a cost data set to said calculated next renewal date to determine a renewal cost;
displaying order information at said computer generated display interface.

20. A method for automated transacting of intellectual property renewals, said method comprising the steps of:
inputting renewals data to a data file at a computer generated display interface, said renewals data comprising data identifying said intellectual property right and a renewals base date;
submitting said data file to a remote computer entity comprising a processing means:
processing said renewals data to calculate a future renewals data set:
displaying calculated future renewals information at said computer generated display interface; and
receiving order confirmation at said remote computer entity.

21. The method as claimed in claim 20, wherein said step of processing said renewals data to calculate a future renewals data set further comprises the step of processing said renewals data to calculate a renewals cost data set.

22. The method as claimed in claim 21, wherein said step of displaying calculated future renewals information further comprises the step of displaying calculated renewals cost data information.

23. The method as claimed in claim 20, further comprising the step of displaying confirmation of the confirmed order at said computer generated display interface.

24. The method as claimed in claim 20, wherein said renewals data comprises:
data identifying a country/region;
data identifying an intellectual property right type;
a file identifier; and
a renewals base date.

25. The method as claimed in claim 20, further comprising the step of inputting payment data at said computer generated display interface and submitting order information to said remote computer entity

26. The method as claimed in claim 20, further comprising the step of altering displayed renewals and/or cost information at said computer generated display interface.

27. A computer program product directly loadable into the internal memory of a digital computer, said computer program product enabling instruction of intellectual property rights renewals via a communications network, said computer program product comprising software code portions for:
generating a computer display interface for input of renewals data to a data file at the computer generated display interface, said renewals data comprising data identifying said intellectual property right and a renewals base date;
applying known renewals rules to said renewals data to calculate a next renewal date;
displaying order information at said computer generated display interface.

28. A computer program product as claimed in claim 27, further comprising software code portions for:
applying a cost data set to said calculated next renewal date to determine a renewal cost.

29. An interface, for inputting data relating to an intellectual property right, said data sufficient to enable renewal of said intellectual property right, said interface comprising:
a data file input component, for inputting a selected data file, said selected data file comprising data identifying said intellectual property right;
wherein, said interface is accessible to the public via a communications network.

30. An interface as claimed in claim 29, wherein said data identifying said intellectual property right comprises:
data identifying a country/region;
data identifying an intellectual property right type; and
a file identifier.

31. An interface as claimed in claim 29, wherein said data identifying said intellectual property right comprises:
data identifying a country/region;
data identifying an intellectual property right type;
a file identifier; and
a renewals base date.

32. An interface as claimed in claim 29, wherein said interface comprises:
a zone selection menu displaying a user selectable list of geographical zones; and
an intellectual property right type selection menu displaying a user selectable list of renewable intellectual property right types; and
an electronic form configured for entry of file identification data and/or renewals base date data.

33. An interface as claimed in claim 30, wherein said file identifier is an intellectual property right application number.

34. An interface as claimed in claim 30, wherein said file identifier is an intellectual property right publication number.

35. An interface as claimed in claim 31, wherein said file identifier is an intellectual property right application number.

36. An interface as claimed in claim 31, wherein said file identifier is an intellectual property right publication number.

37. An interface as claimed in claim 29, wherein data input to said interface is used to calculate a service charge, said service charge displayable at said interface.

38. An intellectual property right renewals instruction order form, automatically computer generated in response to a renewals instruction input at a computer generated display interface and submitted to a remote computer entity via a communications network, said order form comprising:
data identifying an intellectual property right, said data sufficient to enable renewal of said intellectual property right.

39. An order form as claimed in claim 38, wherein said data identifying an intellectual property right comprises:
data identifying a country/region;
data identifying an intellectual property right type; and
a file identifier.

40. An order form as claimed in claim 39, wherein said data identifying an intellectual property right further comprises:
renewal cost data.

41. An order form as claimed in claim 39, wherein said data identifying an intellectual property right further comprises:
renewals base date data.

42. An order form as claimed in claim 38, wherein said order form further comprises:
client payment data and client address and contact data.

43. An intellectual property right renewals confirmation form, automatically computer generated in response to a renewals instruction input at a computer generated display interface and submitted to a remote computer entity via a communications network, said confirmation form comprising:
data identifying an intellectual property right; and
renewals cost data; and
an order confirmation message.

44. An intellectual property right renewals instruction confirmation form as claimed in claim 43, wherein said renewals cost data comprises official fee and/or service charge cost data.
